(19) United States
(12) Patent Application Publication
(10) Pub. No.: US 2004/0205419 A1
(43) Pub. Date: Oct. 14, 2004

(54) Multilevel virus outbreak alert based on collaborative behavior

(75) Inventors: Yung Chang Liang, Cupertino, CA (US); Yi-fen Eva Chen, Pasadena, CA (US)

Correspondence Address: Ya-Chiao Chang c/o, BAKER & McKENZIE, 29th Floor, 805 Third Avenue, New York, NY, 10022, US

(73) Assignee: Trend Micro Incorporated

(21) Appl. No.: 10/411,665

(22) Filed: Apr. 10, 2003

(51) Int. Cl. G06F 11/00

(52) U.S. Cl. 714/57

(57) ABSTRACT

The invention accordingly provides a system and a method for early warning alert method and system for computer virus outbreaks overcoming at least the aforementioned shortcomings in the art. The system and method according to a general embodiment of the invention provides a plurality of alert levels to the end users in optimally reducing the rate of improper detection of viruses and abnormalities in the terminal devices. The invention advantageously provides virus outbreak alert by monitoring collaborative behavior in a network system having a plurality of client devices and at least one server. A preferred embodiment of the method according to the invention comprises the steps of monitoring the activities of the network system using a plurality of sensors in each of the client devices, detecting abnormal events according to rules stored in each of the client devices, reporting abnormalities if abnormal events are detected in one of the client devices, determining or adjusting an alert level for the reported abnormal events, sending an alert to end users, and reporting the abnormal events to the server in the network system.

### BACKGROUND OF THE INVENTION

1. Field of the Invention

The invention relates to early warning of virus outbreaks in a network and, more particularly, to a multilevel outbreak alert based on collaborative behavior in a network.

2. Description of the Related Art

In day-to-day efforts against computer viruses and other terminal device viruses, an end user is constantly looking for solutions against such viruses. Even in the case of corporate networks that are closely guarded by an antivirus firewall and all sorts of virus protection software, some viruses can still penetrate and do great harm. This is because conventional antivirus technology generally relies on already identified viruses. In particular, conventional antivirus protection is usually effective against known computer viruses, but may be ineffective in blocking unknown viruses. A newly captured virus includes to be analyzed by, e.g., an antivirus service provider. Therefore, terminal devices such as computers connected to a local area network (LAN) or wide area network (WAN) is generally unable to include effective antivirus protection against unknown viruses with conventional antivirus software.

When the terminal device or computer connected to a network is subject to attack by an unknown virus penetrating into the network, it is the responsibility of network managers to guard against such attacks and the restore the network to normal operating status as quickly as possible. The level of preparedness in a network is dependent upon knowing the probability of a virus successfully penetrate the corporate network, e.g., LAN. When a computer virus does penetrate into a corporate LAN, the spreading of the virus infection in the network will be only as fast and as effective as end users on the LAN are able to utilize the network. Some of the latest viruses are so fast and ferocious that LAN managers must immediately implement rapid and effective counter-measures in order to reduce the potential damage.

Current antivirus (AV) products generally include two major components, interception of network resources for scanning, and virus scanning. Though such may be quite sufficient for desktop, server, even gateway products, new network-type attacks, such as NIMDA, pose significant challenges. Intrusion Detection System (IDS) products neutralize the network-type attacks by scanning for abnormal network packets at protocols layers, including a method called Application Behavior Monitoring (ABM) at the host base IDS. This application behavior monitor or ABM keeps track of behavioral patterns of target applications and protects the network system by allowing the benign (known) behavior patterns, and by disallowing or blocking and the unknown or malign ones.

Conventional antivirus software still relies on the support system at the antivirus service provider to generate cures. Such practice is heavily reliant on the response time at the service provider in procuring the virus sample, implementing the virus analysis, generating the appropriate cures, and deploying to the end users. Though such antivirus systems may be effective at certain levels, certain end users, e.g., system administrators of corporate networks, still require solutions that provide better lead time and effectiveness in countering sudden outbreaks of computer viruses.

Conventional antivirus systems set a particular alert level in providing early detection of virus outbreaks to system administrators of network systems. The setting of the alert level becomes very important. If the alert level is set too low, it may invite an erroneous determination of a computer virus such that benign applications are deemed viral by mistake. If the alert level is set too high, certain computer viruses will be undetected and allowed into the network. Moreover, conventional antivirus software samples at one computer device at a time such that the totality of sampling becomes insufficient to be statistically responsive.

There is thus a general need in the art for an antivirus method and system overcoming at least the aforementioned shortcomings in the art. In particular, there is a need in the art for an antivirus method and system having multilevel antivirus functions in optimally anticipating and detecting computer virus outbreaks. Moreover, there is a need in the art for an antivirus method and system statistically treating all of the abnormalities in a plurality of computers in optimally reducing the rate of erroneous virus detection.

### SUMMARY OF THE INVENTION

The invention accordingly provides a system and a method for early warning alert method and system for computer virus outbreaks overcoming at least the aforementioned shortcomings in the art. The system and method according to a general embodiment of the invention provides a plurality of alert levels to the end users in optimally reducing the rate of improper detection of viruses and abnormalities in the terminal devices.

The invention advantageously provides virus outbreak alert by monitoring collaborative behavior in a network system having a plurality of client devices and at least one server. A preferred embodiment of the method according to the invention comprises the steps of monitoring the activities of the network system using a plurality of sensors in each of the client devices, detecting abnormal events according to rules stored in each of the client devices, reporting abnormalities if abnormal events are detected in one of the client devices, determining or adjusting an alert level for the reported abnormal events, sending an alert to end users, and reporting the abnormal events to the server in the network system.

The invention advantageously provides virus outbreak alert by monitoring collaborative behavior in a network system having a plurality of client devices and at least one server directly or indirectly connected to the client devices. Another embodiment of the method according to the invention comprises the steps of collecting abnormality event data in the client devices, calculating statistical results of the abnormality events from the client devices, determining whether the abnormality events are computer viruses based on the statistical results, determining if a new alert level is required for the abnormality events, and generating a new alert level (if required) for the client devices.

The invention further provides an antivirus alert system and device based on collaborative behavior in a network system having a plurality of client devices and at least one server directly or indirectly connected to the client devices. Each client device according to another preferred embodiment of the invention comprises a plurality of sensors for monitoring network system activities and determining abnormal events according to abnormality rules, and a data processor for receiving data for the abnormal events from the sensors. The data processor according to this particular embodiment of the invention further comprises a rules engine having rules for determining the alert level for the abnormal events, and an alert device for receiving the alert levels from the sensors and sending alerts to end users. The server receives the data for the abnormal events collected in the client devices. The server comprises a correlative rules engine for calculating statistical results of the abnormality events from the client devices, determining or adjusting the alert level for the abnormal events according to the statistical results, and sending the statistical results to the client devices.

A preferred embodiment of the invention provides an antivirus device in a network system comprising a plurality of clients, each client further comprising a plurality of sensors monitoring system activities in the network system and determining abnormal events based on abnormality rules, a data processor receiving abnormal event data from the sensors, the data processor further comprising a client rules engine having rules for determining an alert level of abnormal events and an alert device receiving the alert level from the sensors, and a server connected to the clients, the server receiving the abnormal event data collected in the clients. Further according to this particular embodiment of the invention, the server further comprises a correlative rules engine calculating a statistical result of the abnormal events at the clients, adjusting the alert level for the abnormal events based on the statistical result, and sending the adjusted alert level to the clients in the network system. The server can also be connected to a rules provider, such as an expert system, for providing new rules and solutions for detecting, isolating, eradicating computer viruses and informing virus information to the correlative rules engine for adding said new rules, or updating and modifying the correlative rules engine. The alert level can further comprise a low alert, middle alert, and high alert.

Another preferred embodiment of the invention further provides an antivirus method in a network system having a plurality of clients and a server connected thereto, each client having a plurality of sensors. The method according to this particular embodiment of the invention comprises the steps of monitoring activities of the network system using the sensors, detecting abnormal events according to abnormality rules stored in the clients, generating abnormal reports if abnormal events are detected, transferring the abnormal reports to a data processor in those of the plurality of clients having the detected abnormal events, determining an alert level for the detected abnormal events, sending an alert, and transferring the abnormal reports to the server in the network system. The alert can further include three alert levels, i.e., a low alert, middle alert, and high alert.

The method according to another embodiment of the invention can further include the step of storing the abnormality rules in a data processor for each of the plurality of clients in the network system. Moreover, the alert level can be determined based on the data traffic flow at the plurality of clients. The alert level can be determined based on the volume of the data traffic flow at the clients in a unit time interval. The method according to the invention can further include the step of designating the data traffic flow as abnormal if the volume of the data traffic flow is larger than a predetermined value in a predetermined time period. Furthermore, the abnormal events can be detected based on the format of the data traffic flow. The method according to the invention can also include the step of designating the data traffic flow as abnormal if its format does not conform to predetermined formats. The alert level can also be determined based on the number of abnormal events not conforming to the predetermined formats. In addition, the alert level can be determined by the extent of deviation of the format of the data traffic flow from the predetermined formats. The method according to yet another embodiment of the invention further comprises the step of mapping predetermined virus patterns to the data traffic flow in determining the alert level. The method according to the invention of claim can further include the step of designating the data traffic flow as abnormal if the data traffic flow conforms to the predetermined virus patterns.

Further according to the invention, the monitored system activities can comprise file-related items including dropping files, infecting files, deleting files and renaming files. The monitored activities can also comprise registry-related items including creating autorun keys, creating and modifying file-association keys, and creating registry markers. Moreover, the monitored activities can comprise initialization-related items including creating autorun keys. The monitored activities can further comprise network-related items including creating shared folders, creating user accounts, and infecting network shared folders. In addition, the monitored activities can further comprise Internet-related items including connecting and downloading from the Internet, opening a socket and port, gathering e-mails, sending e-mails, and sending data. The monitored system activities can also comprise system-related items including checking time, waiting for data payload, recording key events, reading passwords, creating services, hooking application program interfaces, and infecting a boot sector.

### BRIEF DESCRIPTION OF THE DRAWINGS

The foregoing features and advantages of the invention will become more apparent in the following Detailed Description when read in conjunction with the accompanying drawings (not necessarily drawn to scale), in which:

FIG. 1 is a block diagram of an exemplary distributed network management system having an illustrative collaborative antivirus system according to a preferred embodiment of the invention;

FIG. 2 is a block diagram illustrating an exemplary structure of a client device according to another preferred embodiment of the invention;

FIGS. 3 and 3A are flow diagrams illustrating exemplary operational steps in a client device according to a preferred embodiment of the method according to the invention;

FIG. 4 is a block diagram further illustrating a more detailed structure of a server according to yet another embodiment of the invention; and

FIG. 5 is another flow diagram illustrating exemplary operational steps in a server according to another preferred embodiment of the method according to the invention.

### DETAILED DESCRIPTION OF PREFERRED EMBODIMENTS

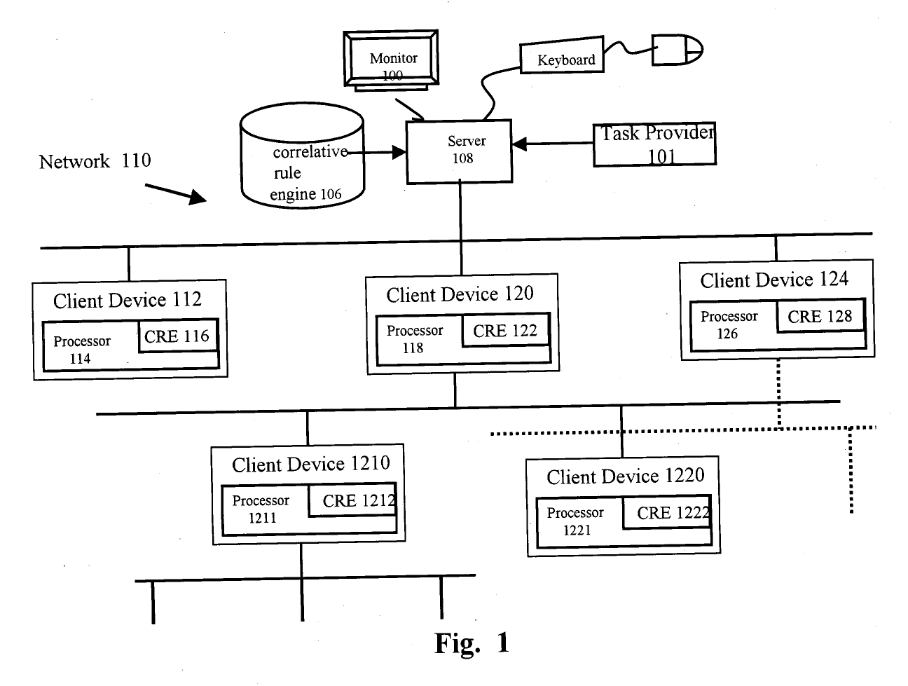

FIG. 1 a block diagram of an exemplary distributed network management system having an illustrative collaborative antivirus system according to a preferred embodiment of the invention. As shown in FIG. 1, the network management system is a distributed computing environment comprising a plurality of individual client devices 108, 112, 120, 124, 1210 and 1220. The client devices are functionally organized into device nodes 112, 120, 124, 1210 and 1220 and at least one server 108 interconnected over a network 110. The client devices 112, 120, 124, 1210 and 1220 and server 108 can also be implemented on a single computer system. The server 108 is a computer that includes user interface devices, such as monitor 100, keyboard 102 and mouse 104. In the described embodiment, each management server 108 is a network-connectible computer or a server device, such as a workstation running an UNIX operating system, or a computer running the Windows™ NT or XP operating system. The management server 108 includes a correlative rules engine 106 having a plurality of rules for detecting computer viruses according to the invention.

It should be noted that in FIG. 1 certain network devices, such as routers, gateways or adapters, along with the required network connections, are not illustrated therein without adversely affecting the results and advantages of the invention. Moreover, the management server 108 can be connected with a rules provider 101 that serves to determine whether the abnormal events are potentially computer viruses in determining or adjusting the alert level for the abnormal events or calculating the statistical results of the abnormal events.

Further according to the invention, each device node, 112, 120, 124, 1210 and 1220, corresponds to a managed device, e.g., a processor, a notebook computer, a desktop computer, or a workstation or other network apparatus. The state of each managed device is monitored and controlled by a data processor running in the device node. For example, processors 114, 118, 128, 1211 and 1212 run in client devices 112, 120, 124, 1210, 1220, respectively. Each processor may also include a client rules engine (CRE) (116, 122, 126, 1212, 1222, respectively) that stores rule information and parameters for detecting computer viruses. The processor and rules engine can be preinstalled in each device node, or generated by the server 108. In operation, a management application program running in the server 108 works in conjunction with the processor 114, 118, 128, 1211 and 1212 in managing the network. The server 108 can download information from the processors 114, 118 and 128 or from their associated rules engines 116, 122, 126, 1212, 1222. The manager server 108 can also set parameters in the devices by instructing the processor programs to set parameters and values within the devices.

Generally, a network is divided into hierarchies such as geographical classification, management classification and detailed information. The hierarchies are accordingly displayed in the form of a map having a plurality of hierarchical levels. With such displayed hierarchies, system or management operator can readily grasp a large-scale, complex network configuration. The device nodes, 112, 120, 124, 1210 and 1220 are formed as a first layer of the network. The network can also be a multiple-layer network, including a first layer, second layer, third layers, etc. As illustrated in FIG. 1, a second layer sub-network is provided, which includes client devices 1210 and 1220. The client device 1210 further includes a processor 1211 and rules engine 1211. The client device 1220 includes a processor 1221 and rules engine 1222

An exemplary collaborative antivirus system according the invention is designed to pick up traces of potential virus outbreaks and accordingly alert the network system administrators before an outbreak materializes. Such a collaborative antivirus system can be linked with automated systems having outbreak counter-measures include virus detection, cure generation and deployment.

An exemplary collaborative antivirus system according to the invention includes a number of major components, i.e., sensors and simple rules engines at client devices, correlative rules engine at servers, and communications channel, management, and backend support, and rules at the client devices or servers as the basis for virus detection.

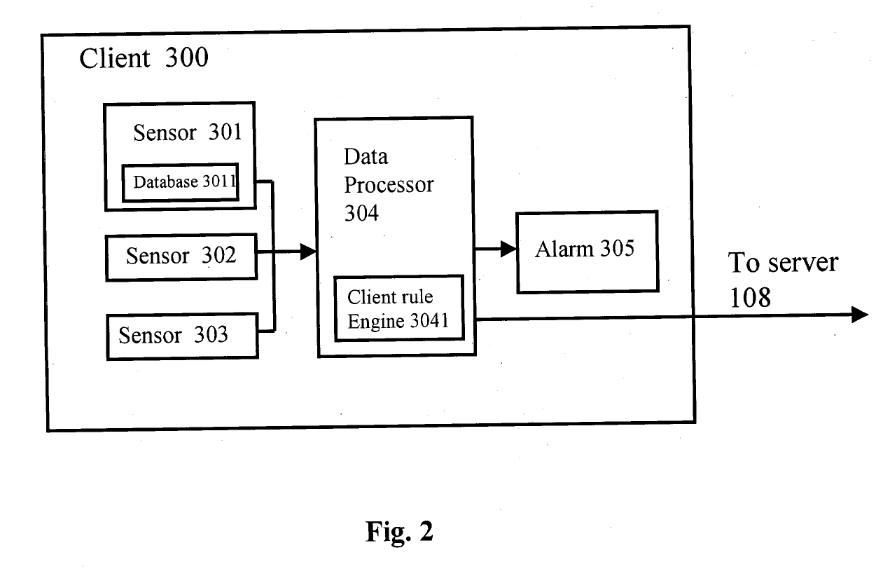

As the collaborative antivirus system according to the invention operates to detect computer viruses, each of the client devices 114, 118, 126 needs to continuously monitor system activities. Referring to FIG. 2, a client device system is illustrated for monitoring system activities. In collaborative action of the client device 30, a plurality of sensors 301, 302 and 303 monitor system activities. These sensors 301, 302 and 303 intercept all kinds of system activities and associate those activities with particular network processes or network resources. Each sensor stores rules for determining abnormality. For example, the sensor 301 includes a database 3011 for storing the abnormality rules, which are described in further detail herein and below. Sensors 301, 302 and 303 then pass the information to a higher layer, or more particularly, sub-components on the client device 30, i.e., data processor 304. The data processor 304 will process the raw data from different sensors, issue high-risk alerts if the data reach or exceed certain thresholds. Although the processor processes most of the raw data, simple virus attacks can be filtered and picked up at lower layers, e.g., by sensors 301, 302 and 303. Upon detection of high-risk alerts, client device components of the collaborative antivirus system according to the invention will send the alerts to the server 108.

The system activities that can be monitored by an exemplary collaborative antivirus system according to the invention are listed in Table 1. Such system activities include file-related items, including activities such as dropping files, infecting files, deleting files, renaming files. Also included are registry-related items, including activities such as creating autorun keys, creating or modifying file-association keys, creating registry markers. Further included are INI-related items (e.g., initialization files), including activities such as creating autorun keys, and network-related items, including activities such as creating shared folders, creating user accounts, and infecting network shared folders. System activities being monitored can also include Internet-related items, including activities such as connecting or downloading from the web, opening a socket or port (backdoor), gathering e-mails in the address book or hypertext markup language (HTML), sending e-mails, and sending data. Further included are system-related items, including activities such as checking time (i.e., waiting for payload), recording key events (i.e., key logging), reading passwords (i.e., password theft), creating services, hooking application program interfaces or APIs, and infecting boot sectors. These system activities are exemplarily illustrated in Table 1, as follows:

TABLE 1
system activities to be monitored

| | |
|---|---|
| File-related items | dropping files, infecting files, deleting files, |
| | renaming files |
| Registry-related items | creating autorun keys, creating/modifying |
| | file-association keys, creating registry markers |
| INI-related items | creating autorun keys |
| Network-related | creating shared folders, creating user |
| items, | accounts, infecting network shared folders |
| Internet-related items | connecting/downloading from web; opening |
| | a socket/port (backdoor); gathering e-mails |
| | (address book/html/asp); sending e-mail/IM; |
| | connecting to IRC; sending data |
| System-related items | checking time (wait for payload); recording |
| | key events (key loggers); reading passwords |
| | (password-stealers); creating service; hooking |
| | APIs, and infecting boot sectors |

The data processors at client devices will keep track of and reference the magnitude of raw data and processed data, data selection and data quantity being based on the rules applied thereto. In implementing these functionalities, highly efficient data storage and retrieval sub-modules are hence required. The sub-modules also provide necessary data management functions on data reorganization and expiration.

In addition to the functionalities of the client devices for a host base Intrusion Detection System (IDS), the collaborative antivirus system according to the invention includes significantly more tolerance at adjusting the risk alert thresholds. A host base IDS sets the alert thresholds very high in order to reduce the rate of false alarms in detecting viruses, which may cause inefficiencies and inflexibilities in dealing with virus outbreaks. In contrast, the collaborative antivirus system adopts multilevel alert thresholds, with the highest alert thresholds being comparable to those of a host base IDS. Below the highest threshold, at least two lower thresholds are maintained in grouping activities at different levels of potential virus outbreak. A plurality of sub-components at a client device of the collaborative antivirus system according to the invention can generate high risk alerts, in addition to alerts generated by sub-components mostly for simple and known virus outbreaks requiring little or no complex computation or identification procedures.

A preferred embodiment of the invention further provides an antivirus method in a network system having a plurality of clients and a server connected thereto, each client having a plurality of sensors. The method according to this particular embodiment of the invention comprises the steps of monitoring activities of the network system using the sensors, detecting abnormal events according to abnormality rules stored in the clients, generating abnormal reports if abnormal events are detected, transferring the abnormal reports to a data processor in those of the plurality of clients having the detected abnormal events, determining an alert level for the detected abnormal events, sending an alert, and transferring the abnormal reports to the server in the network system. The alert can further include three alert levels, i.e., a low alert, middle alert, and high alert.

The method according to another embodiment of the invention can further include the step of storing the abnormality rules in a data processor for each of the plurality of clients in the network system. Moreover, the alert level can be determined based on the data traffic flow at the plurality of clients. The alert level can be determined based on the volume of the data traffic flow at the clients in a unit time interval. The method according to the invention can further include the step of designating the data traffic flow as abnormal if the volume of the data traffic flow is larger than a predetermined value in a predetermined time period. Furthermore, the abnormal events can be detected based on the format of the data traffic flow. The method according to the invention can also include the step of designating the data traffic flow as abnormal if its format does not conform to predetermined formats. The alert level can also be determined based on the number of abnormal events not conforming to the predetermined formats. In addition, the alert level can be determined by the extent of deviation of the format of the data traffic flow from the predetermined formats. The method according to yet another embodiment of the invention further comprises the step of mapping predetermined virus patterns to the data traffic flow in determining the alert level. The method according to the invention of claim can further include the step of designating the data traffic flow as abnormal if the data traffic flow conforms to the predetermined virus patterns.

Further according to the invention, the monitored system activities can comprise file-related items including dropping files, infecting files, deleting files and renaming files. The monitored activities can also comprise registry-related items including creating autorun keys, creating and modifying file-association keys, and creating registry markers. Moreover, the monitored activities can comprise initialization-related items including creating autorun keys. The monitored activities can further comprise network-related items including creating shared folders, creating user accounts, and infecting network shared folders. In addition, the monitored activities can further comprise Internet-related items including connecting and downloading from the Internet, opening a socket and port, gathering e-mails, sending e-mails, and sending data. The monitored system activities can also comprise system-related items including checking time, waiting for data payload, recording key events, reading passwords, creating services, hooking application program interfaces, and infecting a boot sector.

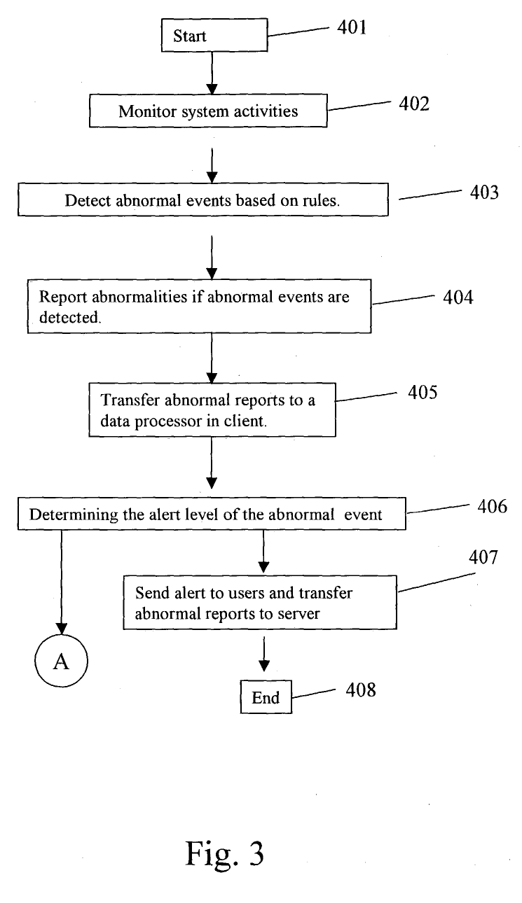

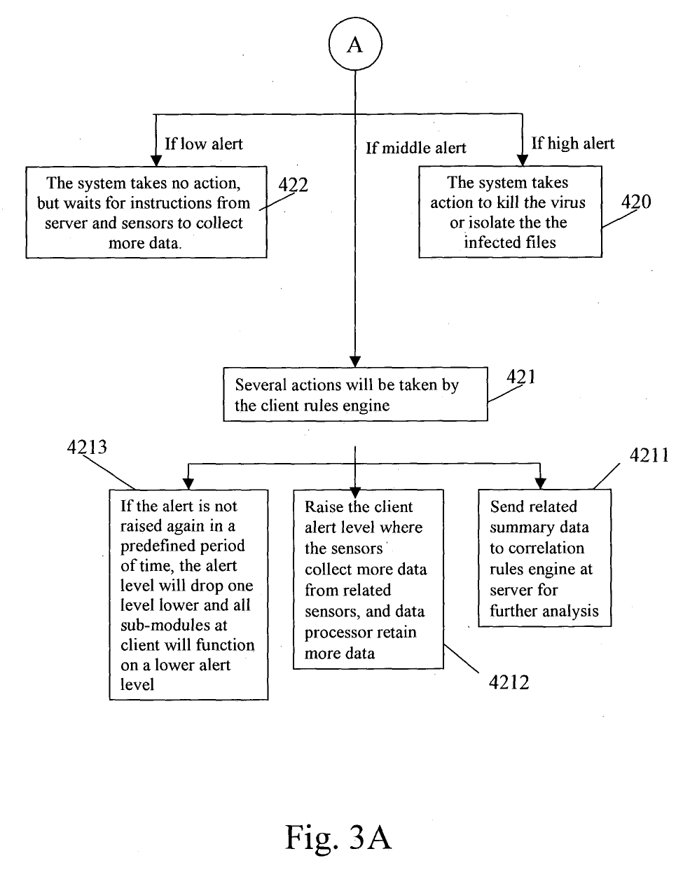

Flow diagrams of exemplary operational steps of a client rules engine 3041 at the client device are illustrated in FIGS. 3 and 3A. A simple rules engine 3041 is designed to continuously calculate the risk index value from the raw and processed data managed by the data storage sub-module. The client rules engine (CRE) 3041 also includes the sub-components having the ability to correlate data from different sensors and generate different levels of alert.

Referring to FIGS. 3 and 3A, the collaborative antivirus system according to the invention is started at step 401. In step 402, a plurality of sensors 301, 302, 303 in the client device 300 monitor the system activities. In step 403, the sensors 301, 302 and 303 detect the abnormal events according to rules on abnormalities. In step 403, the sensors 301, 302, 303 transfer abnormal reports to the data processor 304. In step 404, the data processor 304 report abnormalities if abnormal events are detected in a client device. In step 405, the sensor transfers the abnormality reports to a data processor in a client device. In step 406, the data processor determines the alert level of the abnormal event, which can be a low alert, mid-level alert and a high alert. In step 407, the collaborative antivirus system according to the invention sends an alert in informing an end user of the alert level and transfers the abnormal event to the server so that the end user may accordingly make adjustments. The process steps according to the invention end in step 408. In step 407, other processes are implemented at generally the same time in accordance with the alert levels. The alert levels are divided into a low alert, a middle alert, and a high alert. The details of these levels will be described hereinafter.

A high alert indicates a highly probable virus outbreak. In this case, the high alert could mean that it is very possible that a virus exists and includes broken out. The collaborative antivirus system according to the invention will take action in eradicating the virus or isolating the infected files (step 411). The alert is then sent to the server 106 where pre-defined counters (not shown) measure the particular alert if auto-response is enabled.

A middle alert indicates a possible virus outbreak. In this case, action will be taken by the client device rules engine 3041, including, e.g., sending related summary data to a correlation rules engine 3041 of the server 108 for further analysis (step 4211). Further action can also include, e.g., raising the alert level at the client device causing the sensors 301, 302 and 303 to collect more data from the related sensors, where the data processor 304 will also maintain more related information in the storage (step 4212). Moreover, action taken can include adjusting the alert level at the client device rules engine to a higher alert mode for more computation and analysis. If the alert level is not raised again in a predefined period of time, the alert level will drop one level lower and all sub-modules at the client device will then function at a lesser level of alert (step 4213).

In addition, there could be more than one alert level in the Middle Alert Level Group. Generally speaking, more data will be collected, processed, and analyzed as the alert level is raised. There are also pre-defined and adjustable alert exit conditions for standing down the alert level. Exit conditions might be as simple as, e.g., an expiration of timer/clock, or a false alarm reset command from the server.

A low alert indicates that system behavior is normal. Though most of the activities occur on the client device are in normal operation, it is possible that few of the normal activities are actually part of an attack occurring in the local area network (LAN) environment as a whole. For instance, several infected client devices may join forces in virally attacking a server in a LAN. In a case of a host base Intrusion Detection System (IDS), isolated behavior occurring at the client devices might not even properly raise an alert. The collaborative antivirus system according to the invention advantageously includes the ability to summarize the normal behavior and send it to the server for multi-client correlative behavior monitoring and analysis. Similarly, if the server senses something, it will send respective commands to pertinent client devices to accordingly raise their alert levels, and implement more detailed checks at the client devices (step 422).

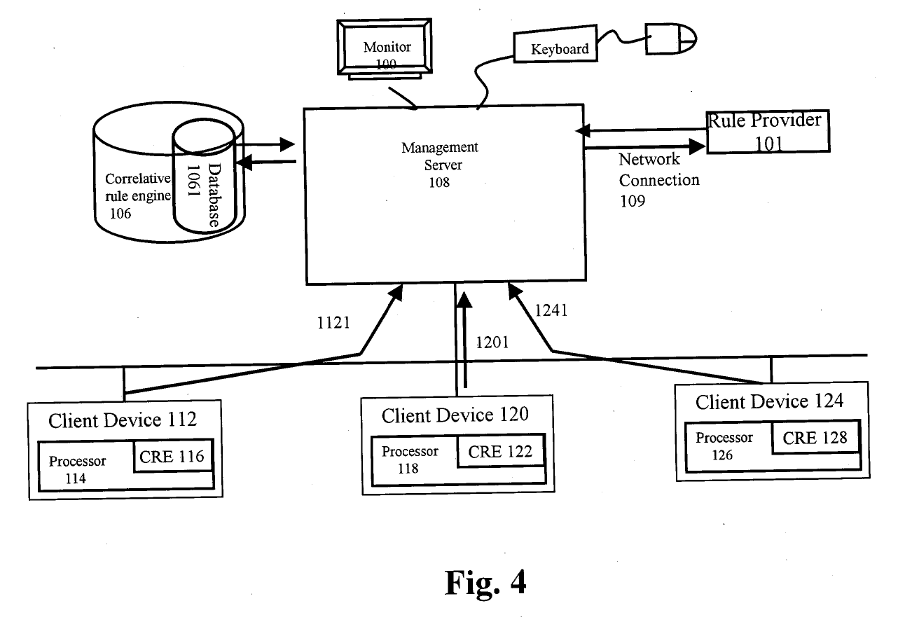

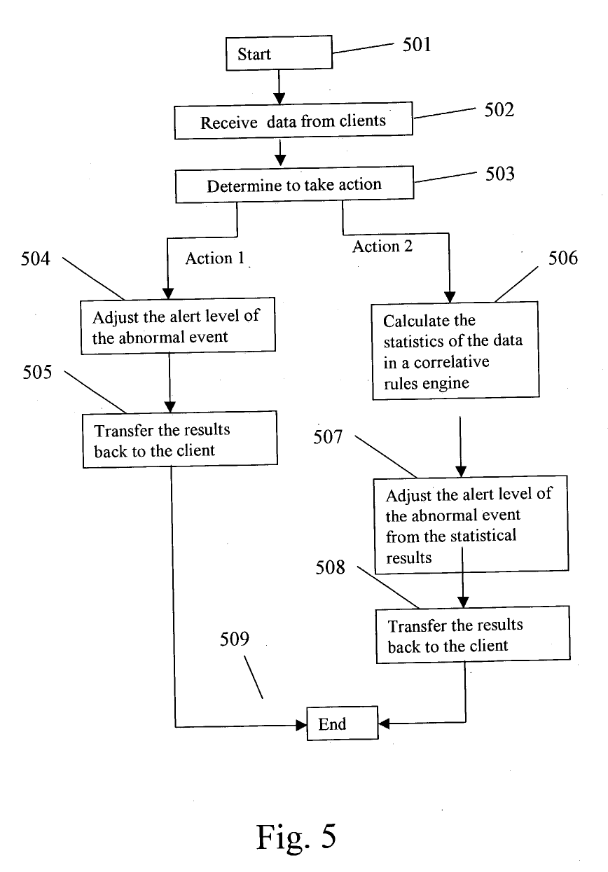

With reference to FIGS. 4 and 5, the server 108 includes a correlative rules engine (CRE) 106. The simple rules engine 3041 at the client device only processes the data from the plurality of sensors 301, 302 and 303, where all of the abnormalities are then sent to the correlative rules engine (CRE) 106 for further analysis. As illustrated in FIG. 4, the data collected in the client devices 112, 120 and 124 are transferred to the server 108 through uplink data paths 1121, 1201 and 1241, respectively (step 502). The data from the client devices 112, 120 and 124 are then processed in the correlative rules engine (CRE) 106. The correlative rules engine 106 analyzes data from all of the client devices, which also includes the ability to maintain and keep track of a plurality of alert levels occurring in different sensors with different client devices.

For a low alert at a client device, generally no action is taken in the client device. A low alert does not ensure that no virus exists. It is possible that a computer virus is at its outbreak inception, or may include a slower infection time, or an unknown virus that the pattern database in the network system has no record of. The server in the collaborative antivirus system according to the invention is advantageously connected to a plurality of client devices, which can collect more data in expeditiously making an effective decision in countering such viruses.

The correlative rules engine (CRE) can take two kinds of actions. One is to directly determine whether the detected abnormality event is potentially a computer virus, i.e., to adjust the alert level of the abnormality event (step 504). This assumes that the correlative rules engine (CRE) is more powerful than the simple rules engine in the client devices 112, 120 or 124. After the correlative rules engine 106 in the server 108 determines a new alert level, the new alert level will be transferred to the client devices 112, 120 or 124 (step 505).

In addition, the correlative rules engine (CRE) can calculate the statistical result of the abnormality events from the client devices 112, 120 and 124 (step 506). The abnormality events sampled in one client device are finite, which cannot provide an effective result to the end users for implementing effective action for isolating or eradicating a computer virus. According to the invention, collecting data from a plurality of client devices will result is statistically effective data that can be effectively responsive in countering potential viruses. The correlative rules engine (CRE) accordingly collects the abnormality events from a plurality of client devices, and determines the statistical results. The correlative rules engine (CRE) 106 then adjusts the alert level of the abnormal event based on the statistics results (step 507). According to this particular embodiment of the method of the invention, the alert level can be determined more accurately and a virus can be detected significantly earlier as the statistical sampling space is much larger. A significantly greater number of samples can be taken at an initial period prior to or proximate to the inception of virus outbreaks. Moreover, if the alert level at the client device is initially erroneous, it can be corrected in the correlative rules engine (CRE) using a large statistical sample in making a more proper determination. The adjusted results are then sent to the client devices 112, 120 and 124 (step 508). The process steps illustrated in FIG. 4 conclude in step 509.

Another important function of the antivirus system according to the invention is the ability to detect virus outbreaks by correlating events from various types of client processors that run on different machines or device nodes for different functions. For example, processors can run on mail server that intercepts and analyzes the mail traffic coming in and out of the mail server. The mail server also monitors application behavior and system resource usage therein. Processors on end user's desktop or notebook can intercept all kinds of file activities and Internet browser traffic, where the processors at the Internet gateway server focus its attention on external threats of viruses.

With respect to the rules for detecting abnormalities according to the invention, the abnormalities detected by the sensors 301, 302, and 303 are based on the detected data traffic flow in all of the device nodes. In particular, the sensors 301, 302 and 303 can detect the volume of data traffic flow in a unit time interval. The sensors can designate the data traffic flow as abnormal if its volume of the unpredicted traffic flow is larger than a predetermined volume of predicted traffic flows for a predetermined time period. The abnormal traffic to be detected may include traffic such as same or similar network traffic sent from a predetermined number of machines or device nodes in a predetermined time period, same or similar network traffic received at a predetermined number of machines or device nodes in a predetermined time period, applications attached to other applications without keyboard or mouse activities, a predetermined number of clients report a predetermined percentage (%) more CPU utilization than usual for a predetermined time period, a predetermined number of sensitive files or registries that had been modified without keyboard or mouse activities, a predetermined number of applications starting without keyboard or mouse activities in a predetermined time period.

Moreover, the sensors 301, 302 and 303 can analyze the format of the data traffic flow and accordingly designate the traffic flow as abnormal if the format does not conform to predetermined formats. Furthermore, the sensors 301, 302 and 303 can map predetermined patterns to the data traffic flow, and designate the traffic flow as abnormal if the format does not conform to predetermined formats. The sensors 301, 302 and 303 can also review and analyze the format of the data traffic flow and accordingly designate the traffic flow as abnormal if the format does not conform with predetermined formats. The alert level is determined by mapping predetermined virus patterns to the data traffic flow.

Other than above-mentioned ways for detecting virus early, in the present invention, the sensors 301, 302 and 303 can detect the modification of files in different client devices 112, 120 and 124. If predetermined abnormalities are detected, the abnormality data are transferred to the server 108 through uplink data paths 1121, 1201 and 1241, respectively. The abnormalities to be detected can include, e.g., same file(s) on a predetermined number of desktops being modifies in a predetermined time period, a plurality of files on a predetermined number of desktops being modified by the same or similar ways in a predetermined time period, a plurality of files on a predetermined number of desktops being modified by the same application(s) in a predetermined time period or same files being created in a predetermined number of directories on a plurality of machines or device nodes in a predetermined time period.

Furthermore, many viruses infiltrate the network system through e-mails or transferred through virus-infected e-mails. The antivirus system according to the invention detects the abnormalities in e-mail systems, which may include, e.g., mailboxes being opened from different machines or device nodes in a predetermined time period, e-mails being sent without keyboard inputs or mouse activities, same or similar e-mail attachments being found in a predetermined number of e-mails in a predetermined time period, same or similar e-mails being forwarded within a predetermined time period after they are opened or received, unusual system behavior or network traffic found after opening an e-mail, same or similar e-mails being sent to a predetermined number of recipients in a predetermined time period, a predetermined number of same or similar e-mails being sent from a single desktop or device node in a predetermined time period, a predetermined number of e-mails being sent from a single desktop or device node in a predetermined time period, or a predetermined number of sensitive files being sent out from a desktop via e-mail or other means.

A further advantage of the antivirus system according to the invention is to collect messages through a network for a summary the network behavior for preemptive virus detection. Certain events of the network system can be detected for preemptively identifying virus attacks including, e.g., a single account being used to log on to a predetermined number of servers from a predetermined number of clients in a predetermined time period, same applications starting on a predetermined number of desktops or device nodes in a predetermined time period, unusual system behavior or network traffic being found after receiving network traffic, a predetermined number of sensitive files being accessed, read or written from the network in a predetermined period of time, network traffic to or from a rarely connected host a predetermined number of clients reporting more network traffic than usual with a predetermined percentage for a predetermined time period, or a predetermined number of machines or device nodes being open on the same port.

In the various embodiments according to the invention, an integral task is to determine the alert levels, for there must be a mechanism for stopping the detection if any of the sensor has discovered no virus in the network system, where a quantification therefor is necessary. For each rule, there will be one or more countermeasures for stopping same or similar detection activities. Because alerts are generated at the server(s) by correlating events from various processors, countermeasures might be sent to processors that have not experienced the particular alert, which can be stopped once same events are detected as a raised alert level on the processors.

Similar to the data storage sub-component on a protected client device, the server 108 of the collaborative antivirus system according to the invention further includes a data storage sub-component in managing the data sent from the client devices. As there are massive volume data to be processed, an expert system integrated solution may be needed, rather than creating an entirely proprietary rules engine, so the network system administrators can focus on creating and fine tuning rules for the server and client device rules. Thus, the rules in the rules engine 106 can be added, modified, changed, edited, and updated. Referring to FIG. 4, a rules provider 101 is connected to the server 108 through a network connection 109. The rules provider 101 may be, for example, a software provider having the capability to generate rules and antivirus solutions for detecting, isolating, eradicating computer viruses and informing users about viruses. For early and preemptive detection of computer viruses, the rules provider 101 can periodically or irregularly update, modify or add the rules in the correlative rules engine (CRE) 106. The correlative rules engine (CRE) 106 further includes a database 1061 having the rules for detecting a virus and virus patterns. The database 1061 can similarly be updated, modified and added with new items by the rules provider 101.

Similar to the client rules engine 3041 at the client devices, the correlative rules engine (CRE) 106 at the server 108 continuously calculates the alert index value of the LAN environment. Whereas the simple rules engine at the client device processes the data from the sensors only, the server rules engine analyzes data from all of the client devices, further including the capability of maintaining and keeping track of different alert levels occurring in various sensors with different client devices. The results at the servers 108 can be transferred to the rules provider 101 for further analysis or other applications.

Furthermore, if the alert is at the middle or high levels, the data processor can implement actions for preventing computer viruses from damaging the files in the network system. For example, in a particular embodiment of the method according to the invention, the data processor can determine which neighborhood of the device nodes in the network: system includes unpredicted traffic flow. The data processor can also designate those of the device nodes having unpredicted traffic flow as abnormal device nodes and those of the device nodes having predicted traffic flow as normal device nodes. At least one network neighborhood monitor can be further deployed for detecting data traffic flow in the abnormal device nodes. A segment in the network system including the abnormal device nodes can be partially isolated, where the data files in the isolated segment are scanned. An antivirus cure is then transferred into the isolated segment for pinpointing at least one infected file among the data files in the network system. All traffic flow into the isolated segment is prevented, except the transferred antivirus cure. Rejecting all normal device nodes in the isolated segment subsequently reduces the size of the isolated segment. At least one infected file is removed from the isolated segment using the antivirus cure.

For the communications channel, management and backend support, the client devices can send summary reports of normal behavior to the server for further correlative checks or monitoring. As the network traffic volume increases in the collaborative antivirus system, efficient communications between network components will be required, where performance degradation of the network system is advantageously prevented. In reducing the network traffic volume, the client devices may need to compress the data, process the data and report summaries of the data only, or develop data protocols allowing data transfer only upon server request.

A further embodiment of the collaborative antivirus system according to the invention will log activities, e.g., activities or alert logs, including alert level promotion or demotion, operation logs including rule setup, update, upgrade or change, further including notification capabilities using existing notification modules in the network system. In addition to ease of use, the collaborative antivirus system according to the invention can further include a protected user interface for end users to perform management tasks, including product or rule upgrade, log viewing or reporting, threshold fine tuning, system enable or disable functions.

Further according to the collaborative antivirus system of the invention, a process is maintained for collecting virus samples, analyzing system behavior and network activities should there be infected client devices, and fine-tuning the rules and thresholds for different alert levels.

It would be apparent to one skilled in the art that the invention can be embodied in various ways and implemented in many variations. For instance, a network of computers is described herein in illustrating various embodiments of the invention. The invention is accordingly applicable in this and other types of networks, such as a metropolitan area network (MAN), a wide area network (WAN), a local area network (LAN) or even wireless communications networks for mobile phones and personal digital assistant (PDA) devices. Such variations are not to be regarded as a departure from the spirit and scope of the invention. In particular, the process steps of the method according to the invention will include methods having substantially the same process steps as the method of the invention to achieve substantially the same results. Substitutions and modifications include been suggested in the foregoing Detailed Description, and others will occur to one of ordinary skill in the art. All such modifications as would be obvious to one skilled in the art are intended to be included within the scope of the following claims and their equivalents.

We claim:

1. An antivirus method in a network system having a plurality of clients and a server connected thereto, each client having a plurality of sensors, the method comprising the steps of:
monitoring activities of said network system using said sensors;
detecting abnormal events according to abnormality rules stored in said clients;
generating abnormal reports if abnormal events are detected;
transferring said abnormal reports to a data processor in those of said clients having said detected abnormal events;
determining an alert level for said detected abnormal events;
sending an alert; and
transferring said abnormal reports to said server.

2. The method of claim 1 said alert further comprising three alert levels including low alert, middle alert, and high alert.

3. The method of claim 1 further comprising the step of storing said abnormality rules in a data processor for each of said clients.

4. The method of claim 1 wherein said alert level is determined based on data traffic flow at said clients.

5. The method of claim 1, said abnormal events further comprising same or similar network traffic being sent from a predetermined number of said clients in a predetermined time period.

6. The method of claim 1, said abnormal events further comprising same or similar network traffic being received at a predetermined number of said clients in a predetermined time period.

7. The method of claim 1, said abnormal events further comprising applications being attached to other applications without keyboard or mouse activities.

8. The method of claim 1, said abnormal events further comprising same files on a predetermined number of said clients being modified in a predetermined time period.

9. The method of claim 1, said abnormal events further comprising a plurality of files on a predetermined number of said clients being modified by substantially similar ways in a predetermined time period.

10. The method of claim 1, said abnormal events further comprising a plurality of files on a predetermined number of said clients being modified by same applications in a predetermined time period.

11. The method of claim 1, said abnormal events further comprising same files being created in a predetermined number of directories on said clients in a predetermined time period.

12. The method of claim 1, said abnormal events further comprising a predetermined number of sensitive files or registries that had been modified without keyboard or mouse activities.

13. The method of claim 1, said abnormal events further comprising a predetermined number of applications starting without keyboard or mouse activities in a predetermined period of time.

14. The method of claim 1, said abnormal events further comprising a single mailbox being opened from different clients in a predetermined timer period.

15. The method of claim 1, said abnormal events further comprising e-mails being sent without keyboard inputs or mouse activities.

16. The method of claim 1, said abnormal events further comprising same or similar e-mail attachments are found in a predetermined number of e-mails in a predetermined time period.

17. The method of claim 1, said abnormal events further comprising same or similar e-mails being forwarded within a predetermined time period after they are opened or received.

18. The method of claim 1, said abnormal events further comprising same or similar e-mails being sent to a predetermined number of recipients in a predetermined time period.

19. The method of claim 1, said abnormal events further comprising a predetermined number of same or similar e-mails being sent out from one of said clients in a predetermined time period.

20. The method of claim 1, said abnormal events further comprising a predetermined number of e-mails being sent from one of said clients in a predetermined time period.

21. The method of claim 1, said abnormal events further comprising a single account being used to log on to a first predetermined number of said server from a second predetermined number of said clients in a predetermined time period.

22. The method of claim 1, said abnormal events further comprising same applications starting on a predetermined number of said clients in a predetermined time period.

23. The method of claim 1, said abnormal events further comprising a predetermined number of sensitive files having been accessed, read or written from said network system in a predetermined period of time.

24. The method of claim 1, said abnormal events further comprising network traffic to or from a rarely connected host.

25. The method of claim 1, said abnormal events further comprising a predetermined number of said clients reporting more network traffic than usual traffic with a predetermined percentage for a predetermined time period.

26. The method of claim 1, said abnormal events further comprising a predetermined number of said clients being opened on a same port.

27. The method of claim 4 further comprising the step of designating said data traffic flow as abnormal if a volume of said data traffic flow is larger than a predetermined value in a predetermined time period.

28. The method of claim 4 wherein said abnormal events are detected based on a format of said data traffic flow.

29. The method of claim 28 further comprising the step of designating said data traffic flow as abnormal if said format does not conform to predetermined formats.

30. The method of claim 29 wherein said alert level is determined based on a number of abnormal events not conforming to said predetermined formats.

31. The method of claim 29 wherein said alert level is determined by an extent of deviation of said format from said predetermined formats.

32. The method of claim 4 further comprising the step of mapping predetermined virus patterns to said data traffic flow in determining said alert level.

33. The method of claim 32 further comprising the step of designating said data traffic flow as abnormal if said data traffic flow conforms to said predetermined virus patterns.

34. The method of claim 1, said monitored activities further comprising file-related items including dropping files, infecting files, deleting files and renaming files.

35. The method of claim 1, said monitored activities further comprising registry-related items including creating autorun keys, creating and modifying file-association keys, and creating registry markers.

36. The method of claim 1, said monitored activities further comprising initialization-related items including creating autorun keys.

37. The method of claim 1, said monitored activities further comprising network-related items including creating shared folders, creating user accounts, and infecting network shared folders.

38. The method of claim 1, said monitored activities further comprising Internet-related items including connecting and downloading from the Internet, opening a socket and port, gathering e-mails, sending e-mails, and sending data.

39. The method of claim 1, said monitored activities further comprising system-related items including checking time, waiting for data payload, recording key events, reading passwords, creating services, hooking application program interfaces, and infecting a boot sector.

40. An antivirus method in a network system having a plurality of clients and a server connected thereto, each of said clients having a plurality of sensors, the method comprising the steps of:
monitoring system activities at each of said sensors;
generating abnormality reports to a data processor in said clients;
transferring said abnormality reports to said server;
receiving abnormal event data collected in said clients by said server;
determining whether said abnormal events are computer viruses;
adjusting an alert level to generate a new alert level; and
transferring said new alert level back to said clients.

41. The method of claim 40 further comprising the step of analyzing data from all of said clients using a correlative rules engine in said server.

42. The method of claim 40 further comprising the step of maintaining and keeping track of different alert levels occurring in said clients using a correlative rules engine in said server.

43. The method of claim 40, said alert level further comprising a low alert, middle alert, and high alert.

44. An antivirus method in a network system having a plurality of clients and a server connected thereto, each of said clients having a plurality of sensors, the method comprising the steps of:
monitoring system activities at each of said sensors;
generating abnormality reports to a data processor in said clients;
transferring said abnormality reports to said server;
receiving abnormality event data collected in said clients by said server for a plurality of abnormal events;
calculating a statistical result of said abnormal events from said clients;
determining whether said abnormal events are computer viruses based on said statistical result;
adjusting an alert level to a new alert level; and
transferring said new alert level back to said clients.

45. The method of claim 44 further comprising the step of analyzing data from all of said clients using a correlative rules engine in said server.

46. The method of claim 44 further comprising the step of maintaining and keeping track of different alert levels occurring in said clients using a correlative rules engine in said server.

47. The method of claim 46, said alert level further comprising a low alert, middle alert, and high alert.

48. An antivirus device in a network system comprising:
a plurality of clients, each client further comprising a plurality of sensors monitoring system activities in said network system and determining abnormal events based on abnormality rules;
a data processor receiving abnormal event data from said sensors, said data processor further comprising a client rules engine having rules for determining an alert level of abnormal events and an alert device receiving said alert level from said sensors;
a server connected to said clients, said server receiving said abnormal event data collected in said clients, said server further comprising a correlative rules engine calculating a statistical result of said abnormal events at said clients, adjusting said alert level for said abnormal events based on said statistical result, and sending said adjusted alert level to said clients.

49. The device of claim 48 wherein said server is connected to a rules provider providing new rules and solutions for detecting, isolating, eradicating computer viruses and informing virus information to said correlative rules engine for adding said new rules, updating and modifying said correlative rules engine.

50. The device of claim 48, said alert level further comprising a low alert, middle alert, and high alert.
